(19) United States
(12) Patent Application Publication
(10) Pub. No.: US 2018/0216629 A1
(43) Pub. Date: Aug. 2, 2018

(54) Radial Compressor and Turbocharger

(71) Applicant: MAN DIESEL & TURBO SE, Augsburg (DE)

(72) Inventors: Hannes BENETSCHIK, München (DE); Benjamin Eduard WILKOSZ, Hollenbach (DE); Christoph HEINZ, Langenau (DE); Andreas LESSER, München (DE)

(73) Assignee: MAN DIESEL & TURBO SE

(21) Appl. No.: 15/881,399

(22) Filed: Jan. 26, 2018

(30) Foreign Application Priority Data
Jan. 27, 2017 (DE) 102017101590.6

(51) Int. Cl. F04D 29/44; F02B 33/40; F04D 29/42

(52) U.S. Cl. CPC F04D 29/444; F02B 37/00; F04D 29/4206; F02B 33/40

(57) ABSTRACT

A radial compressor having a compressor rotor with blades; a compressor housing, a diffuser having guide vanes. The diffuser delimits a flow duct in radial direction. The guide vanes of have a flow inlet edge, a flow outlet edge, and flow-conducting sides. The guide vanes project into the flow duct that is delimited by the diffuser. The guide vanes merge into a support body subject to forming a curvature region that is defined on the flow side. In each position of the curvature region, i.e. in the region of the flow inlet edge, in the region of the flow outlet edge and in regions between the flow inlet edge and the flow outlet edge a curvature radius that is defined on the flow side is formed in each case.

### BACKGROUND OF THE INVENTION

### 1. Field of the Invention

The invention relates to a radial compressor and to a turbocharger. More particularly, the present invention relates to a radial compressor of a turbocharger and to a turbocharger having a radial compressor.

### 2. Description of the Related Art

Turbochargers have a compressor and a turbine. In the turbine of a turbocharger, a first medium, in particular exhaust gas of an internal combustion engine, is expanded and energy extracted in the process is utilised in the compressor of the turbocharger to compress a second medium, in particular charge air for the internal combustion engine.

A radial compressor of a turbocharger comprises a compressor housing and a compressor rotor. The compressor rotor of the radial compressor is subjected to axial inflow and radial outflow, wherein the compressor rotor carries moving blades. Typically, the compressor housing accommodates an insert piece and a diffuser, wherein the insert piece delimits, at least in sections, a flow duct leading to the moving blades of the rotor and the diffuser a flow duct leading away from the moving blades of the rotor.

EP 1 340 920 B1 discloses a radial compressor with a diffuser. The diffuser of the radial compressor disclosed comprises guide vanes. The guide vanes of the diffuser act on a support body of the diffuser formed as a plate.

### SUMMARY OF THE INVENTION

One aspect of the present invention is a new type of radial compressor which comprises an expanded pump stability limit, and a turbocharger having such a radial compressor. According to one aspect of the invention, the guide vanes of the diffuser merge into the support body of the diffuser subject to forming a curvature region defined on the flow side, wherein in each position of the curvature region, i.e. in the region of the flow inlet edge, in the region of the flow outlet edge and in regions between the flow inlet edge and the flow outlet edge, a curvature radius that is defined in each case on the flow side is formed. By way of this, the pump stability limit of the radial compressor can be expanded.

According to a first advantageous further development, a constant curvature radius is formed in each case in each position of the curvature region. Preferentially, a ratio of the respective curvature radius to the radial diameter of the compressor is greater than or equal to 0.015, preferably greater than or equal to 0.02, particularly preferably greater than or equal to 0.025. A ratio of the respective minimum curvature radius to the axial height of the respective guide vane of the diffuser is preferentially smaller than or equal to one. By way of this, the pump stability limit of the radial compressor can be advantageously expanded.

According to a second alternative advantageous further development, a variable curvature radius, which varies between a minimum curvature radius and a maximum curvature radius is formed in each case in each position of the curvature region. Preferentially, a ratio of the respective maximum curvature radius to the radial diameter of the compressor rotor is greater than or equal to 0.015, preferably greater than or equal to 0.02, particularly preferably greater than or equal to 0.025. A ratio of the respective minimum curvature radius to the axial height of the respective guide vane of the diffuser is preferentially smaller than or equal to 1. By way of this, the pump stability limit of the radial compressor can also be advantageously expanded.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1 is an axial section through a radial compressor;

FIG. 2 is a detail of FIG. 1;

FIG. 3 is an alternative detail of FIG. 1; and

FIG. 4 is an axial section through a further radial compressor.

### DETAILED DESCRIPTION OF THE PRESENTLY PREFERRED EMBODIMENTS

The invention relates to a radial compressor and to a turbocharger having a radial compressor. The person skilled in the art addressed here is familiar with the fundamental construction of a turbocharger. It is pointed out here that a turbocharger comprises a compressor and a turbine. In the turbine of the turbocharger, a first medium, in particular exhaust gas, is expanded. The energy extracted during the expansion of the first medium is utilised in the compressor to compress a second medium, in particular charge air.

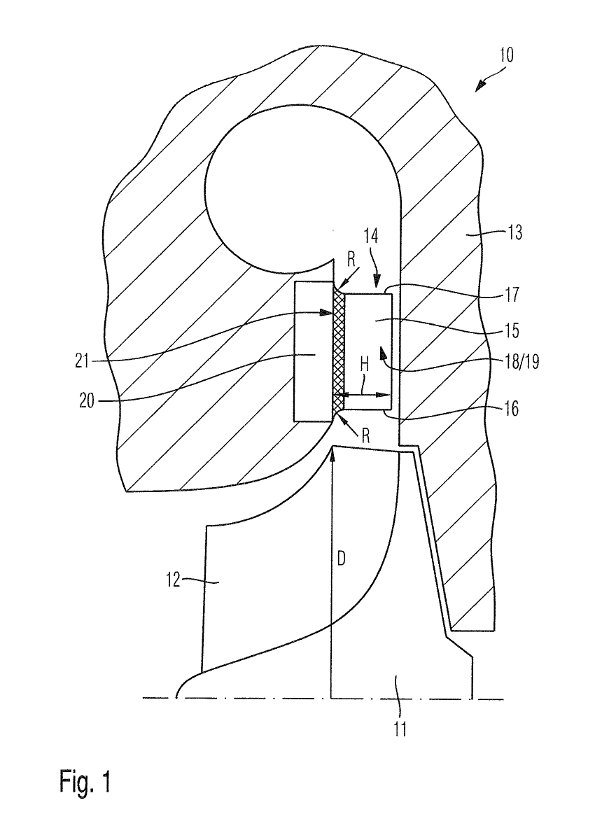

FIG. 1 shows a schematic cross section through a first radial compressor 10, wherein the radial compressor 10 comprises a compressor rotor 11 with moving blades 12 and a compressor housing 13. The compressor housing 13 accommodates a diffuser 14 with guide vanes 15, wherein the diffuser 14 downstream of the compressor rotor 11 delimits, in sections, a flow duct extending in radial direction and extending or leading away from the moving blades 12 of the compressor rotor 11 in radial direction.

A medium to be compressed in the radial compressor flows into the compressor rotor 11 in axial direction and flows out of the same in radial direction, namely via the diffuser 14 with the guide vanes 15.

Each guide vane 15 of the diffuser 14 has a flow inlet edge 16, a flow outlet edge 17 and flow-conducting sides 18, 19 extending between the flow inlet edge 16 and the flow outlet edge 17.

The guide vanes 15 of the diffuser 14 act on a plate-like support body 20 of the diffuser 14, wherein the diffuser 14 is fastened to the compressor housing 13 via the support body 20. Starting out from the support body 20, the guide vanes 15 of the diffuser 14 extend into the flow duct of the radial compressor 10 extending in radial direction downstream of the compressor rotor 11.

In the sense of the present invention, the guide vanes 15 of the diffuser 14 merge into the support body 20 of the diffuser 14 subject to forming a curvature region 21 defined on the flow side.

This curvature region 21 defined on the flow side circulates about the respective guide vane 15 of the diffuser 14 in the transition region to the support body 20 of the diffuser 14, so that accordingly this curvature region 21 is formed both in the region of the flow inlet edge 16 of the respective guide vane 15 and also in the region of the flow outlet edge 17 of the respective guide vane 15 as well as in the region of the flow-conducting sides 18 and 19 of the respective guide vane 15 running between the flow inlet edge 16 and the flow outlet edge 17.

In each position of the curvature region 21, i.e. in the region of the flow inlet edge 16, in the region of the flow outlet edge 17 and in the region of the flow-conducting sides 18, 19 extending between the flow inlet edge 16 and the flow outlet edge 17 a defined curvature radius R is formed in each case. In the exemplary embodiment of FIG. 1, this curvature radius R is constant in each case in each position of the curvature region 21, while, furthermore, the same defined, constant curvature radius R is formed in the exemplary embodiment of FIG. 1 in each position of the curvature region 21.

Here it is provided, in particular, that a ratio R/D of the curvature radius R to the radial diameter D of the compressor rotor 11 is greater than or equal to 0.015, preferably greater than or equal to 0.02, particularly preferably greater than or equal to 0.025.

A ratio R/H between the respective curvature radius R and the axial height H of the respective guide vane 15 of the diffuser 14 is smaller than or equal to 1.

The radial compressor 10 according to one aspect of the invention with the curvature region 21 defined on the flow side between the guide vanes 15 of the diffuser 14 and the support body 20 of the same ensures an expanded pump stability limit of the radial compressor, in particular in the full-load range. Because of this, an increase of the utilisable characteristic map width can be realised. Because of this, an expanded motor operating range can be covered and/or an increase of the charge pressure achieved.

Furthermore, the expansion of the pump stability limit makes possible a more robust functionality of the radial compressor during a transient load change, for example upon an acceleration of the turbocharger.

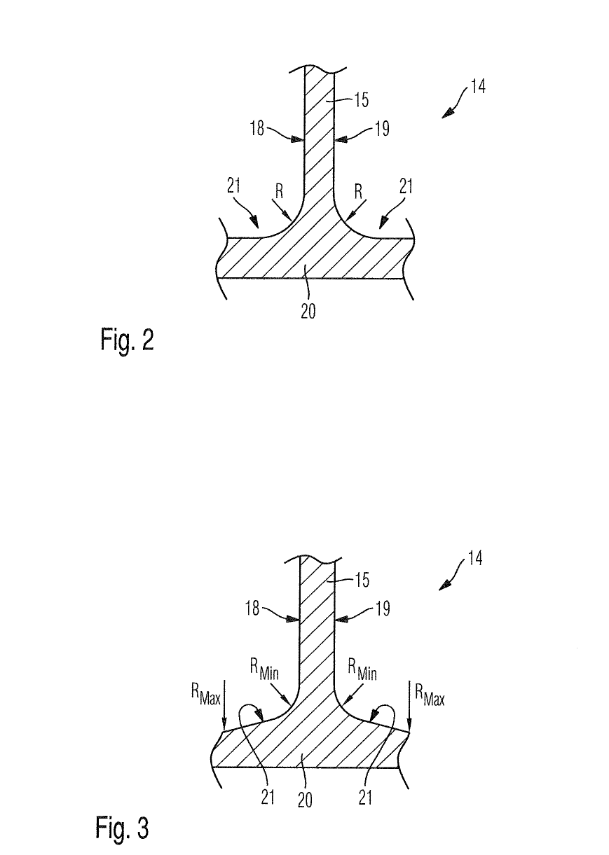

FIG. 2 shows a detail from the radial compressor 10 of FIG. 1 in the region of a guide vane 15 of the diffuser 14, namely in the transition region between curvature region 21 between the guide vane 15 of the diffuser 14 and the support body 20 of the diffuser 14. As already explained, the same defined, constant curvature radius R is formed in each case in the exemplary embodiment of FIG. 1, 2 in each position of the curvature region 21, i.e. in the region of the flow inlet edge 16, in the region of the flow outlet edge 17, and in the region of the flow-conducting sides 18, 19 running between the flow inlet edge 16 and the flow outlet edge 17.

Compared with this, FIG. 4 shows a schematic cross section through a radial compressor 10, with which in each position of the curvature region 21 a defined, constant curvature radius is again formed on the flow side in each case, wherein however the constant curvature radius formed on the or each position of the curvature region 21, changes, in particular diminishes starting out from the flow inlet edge 16 in the direction of the flow outlet edge 17. FIG. 4 shows that in the region of the flow inlet edge 16 the constant curvature radius R2 and in the region of the flow outlet edge 17 the constant curvature radius R1 is formed in the curvature region 21, wherein starting out from the flow inlet edge 16 in the direction of the flow outlet edge 17, in the region of the flow-conducting sides 18, 19, a further constant curvature radius is formed in each position, which diminishes starting out from the radius R2 at the flow inlet edge 16 in the direction of the radius R1 on the flow outlet edge 17.

The above stated ratios R/D and R/H, which were described making reference to FIG. 1, apply to each of these curvature radii, i.e. also to the curvature radii R2 and R1.

In particular when, as shown in FIGS. 1, 2 and 4, a constant curvature radius R, R1 and R2 respectively is formed in each position of the curvature region 21 thus the guide vane 15 merge into the support body 20 of the diffuser 14 subject to forming a segment of a circle, in particular a ¼ segment of a circle.

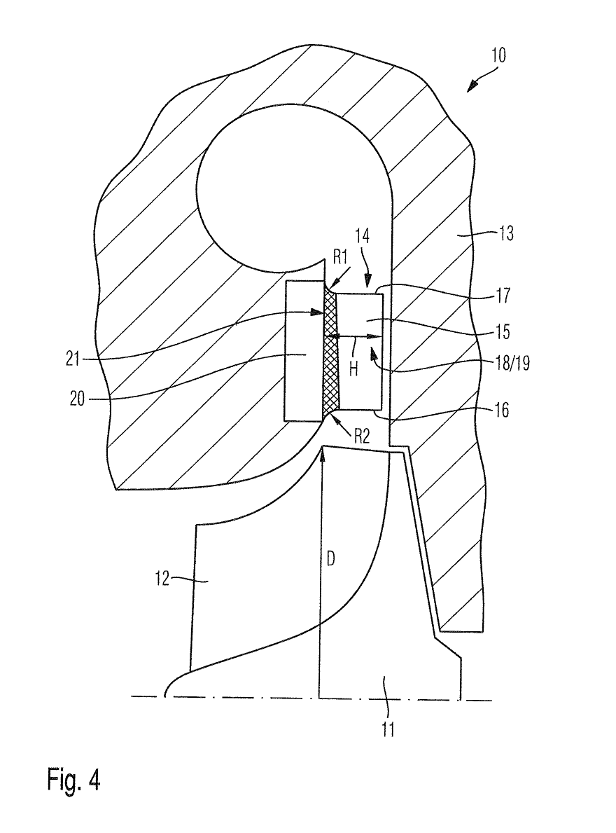

According to an alternative configuration of a radial compressor 10 it is provided that in each position of the curvature region 21 defined on the flow side a curvature radius that is defined on the flow side is formed, which varies or merges between a minimum curvature radius R_{MIN} and a maximum curvature radius R_{MAX}. This is shown by FIG. 3.

Accordingly, the curvature radius R, in the exemplary embodiment of FIG. 3, adjacent to the respective guide vane 15 is smaller than adjacent to the support body 20. In this case, the curvature region 21 between a guide vane 15 and the support body 20 is then not formed in the sense of a segment of a circle, but rather in the sense of a segment of an ellipse or similar. In the version of FIG. 3 a ration R_{MAX}/D of the respective maximum curvature radius R_{MAX} to the radial diameter D of the compressor rotor 11 is greater than or equal to 0.015, preferably greater than or equal to 0.02, particularly preferably greater than or equal to 0.025. Furthermore, the ratio R_{MIN}/H of the respective minimum curvature radius R_{MIN} to the axial height H of the respective guide vane 15 of the diffuser 14 is smaller than or equal to 1.

It is mentioned here that the invention also comprises the reverse case that the minimum curvature radius is on the housing and the maximum curvature radius on the blade.

In the version of FIG. 3 it can be provided that in each position of the curvature region 21, i.e. in the region of the flow inlet edge 16, the flow outlet edge 17 and the flow-conducting surfaces 18, 19 extending between the flow inlet edge 16 and the flow outlet edge 17 in each case the same variable curvature radius is formed, so that in each position of the curvature region 21 the same minimum curvature radius R_{MIN}, the maximum curvature radius R_{MAX} and the same transition between the same is formed.

However it is also possible that the maximum curvature radius R_{MAX} formed in each position of the curvature region 21 changes, in particular diminishes, starting out from the flow inlet edge in the direction of the flow outlet edge 17. It is likewise possible that the minimum curvature radius R_{MIN}, starting out from the flow inlet edge 16 additionally also changes, in particular diminishes in the direction of the flow outlet edge 17.

The purpose of the present invention therefore is to propose a radial compressor 10 for a turbocharger and a turbocharger having such a radial compressor 10, the diffuser guide vane 15 of which merge, with a curvature region 21 defined on the flow side, into a support body 20 of the diffuser 14, as a result of which the stability limit of the radial compressor can be increased, in particular in the full-load range. Because of this, the utilisable characteristic map width can be enlarged, as a result of which an expanded motor operating range and/or an increase of the charge pressure can be achieved. The expansion of the pump stability limit, furthermore, increases the robust functionality of the compressor during a transient load change. In the case that the compressor rotor 11 should be damaged, the support blade 20 of the diffuser 14 can function as bursting ring and absorb forces and moments thereby increasing the containment safety of the compressor 10. The curvature region 21, via which the respective diffusor guide vane 14 merges into the support body 20 of the diffuser 14 is located on the same side of the flow duct extending in radial direction as the support body 20 of the diffuser 14. Because of this, a meridian adaptation can be effected via the support body 20 of the diffuser 14. Separate compensation components for providing such a meridian adaptation can be omitted. Because of this, the number of the components is minimised and the tolerance chain reduced.

In this regard, the invention is applicable both to diffuser blades, which are integrated in the turbocharger housing and also to versions embodied as insert piece.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A radial compressor, comprising:
a compressor rotor comprising moving blades;
a compressor housing;
a diffuser receive in the compressor housing and comprising guide vanes, wherein the diffuser, at least in sections, delimits a flow duct leading away from the moving blades of the compressor rotor in radial direction;
wherein each guide vane of the diffuser comprises a flow inlet edge, a flow outlet edge, and flow-conducting sides extending between the flow inlet edge and the flow outlet edge and project into the flow duct which is delimited by the diffuser at least in sections; and
a support body of the diffuser upon which the guide vanes of the diffuser act;
wherein the guide vanes of the diffuser merge into the support body of the diffuser subject to forming a curvature region defined on a flow side; and
wherein in each position of the curvature region, including one or more of a region of the flow inlet edge, a region of the flow outlet edge, and regions between the flow inlet edge and the flow outlet edge, a curvature radius defined on the flow side is formed in each case.

2. The radial compressor according to claim 1, wherein in each position of the curvature region a constant curvature radius is formed in each case.

3. The radial compressor according to claim 2, wherein a ratio of the respective curvature radius to a radial diameter of the compressor rotor is at least one of:
greater than or equal to 0.015,
greater than or equal to 0.02, and
greater than or equal to 0.25.

4. The radial compressor according to claim 2, wherein a ratio of the respective curvature radius to an axial height of each respective guide vane of the diffuser is smaller than or equal to 1.

5. The radial compressor according to claim 2, wherein in each position of the curvature region a same defined constant curvature radius is formed.

6. The radial compressor according to claim 2, wherein the defined, constant curvature radius formed in each position of the curvature region changes by diminishing starting out from the flow inlet edge in a direction of the flow outlet edge.

7. The radial compressor according to claim 1, wherein in each position of the curvature region a variable curvature radius is formed that varies between a minimum curvature radius (R_{MIN}) and a maximum curvature radius.

8. The radial compressor according to claim 7, wherein a ratio of a respective maximum curvature radius to a radial diameter of the compressor rotor is at least one of:
greater than or equal to 0.015,
greater than or equal to 0.02, and
greater than or equal to 0.25.

9. The radial compressor according to claim 7, wherein a ratio of a respective minimum curvature radius to an axial height of each respective guide vane of the diffuser is smaller than or equal to 1.

10. The radial compressor according to claim 7, wherein in each position of the curvature region a same variable curvature radius is formed.

11. The radial compressor according to claim 7, wherein at least one of:
the maximum curvature radius formed in each position of the curvature region changes by diminishing starting out from the flow inlet edge in the region of the flow outlet edge and
the minimum curvature radius formed in each position of the curvature region changes by diminishing starting out from the flow inlet edge in the region of the flow outlet edge.

12. The radial compressor according to claim 1, wherein the guide vanes of the diffuser are integrated in the compressor housing.

13. A turbocharger, comprising:
a turbine configured to expand a first medium comprising a turbine housing and a turbine rotor;
a radial compressor configured to compress a second medium utilising energy extracted in the turbine during expansion of the first medium, comprising a compressor housing and a compressor rotor that is coupled to the turbine rotor via a shaft, wherein the radial compressor comprises:
a compressor rotor comprising moving blades;
a compressor housing;
a diffuser receive in the compressor housing and comprising guide vanes, wherein the diffuser, at least in sections, delimits a flow duct leading away from the moving blades of the compressor rotor in radial direction;
wherein each guide vane of the diffuser comprises a flow inlet edge, a flow outlet edge, and flow-conducting sides extending between the flow inlet edge and the flow outlet edge and project into the flow duct which is delimited by the diffuser at least in sections; and
a support body of the diffuser upon which the guide vanes of the diffuser act;
wherein the guide vanes of the diffuser merge into the support body of the diffuser subject to forming a curvature region defined on a flow side; and
wherein in each position of the curvature region, including one or more of a region of the flow inlet edge, a region of the flow outlet edge, and regions between the flow inlet edge and the flow outlet edge, a curvature radius defined on the flow side is formed in each case.
